(19) United States
(12) Patent Application Publication
(10) Pub. No.: US 2015/0379489 A1
(43) Pub. Date: Dec. 31, 2015

(54) DEVICE INFORMATION ON A SELF-SERVICE TERMINAL

(71) Applicant: NCR Corporation, Duluth, GA (US)

(72) Inventors: Muthukumar Gopalakrishnan, Duluth, GA (US); Sirisha Takasi, Hyderabad (IN); Ian M. Joy, Dundee (GB)

(21) Appl. No.: 14/317,574

(22) Filed: Jun. 27, 2014

(51) Int. Cl. G06Q 20/10; G06Q 20/34

(52) U.S. Cl. CPC G06Q 20/1085; G06Q 20/3567

(57) ABSTRACT

A method and terminal are provided for maintaining media and operational information for devices connected to a self service terminal. Self service terminals such as automatic teller machines (ATM) support multiple applications that use the devices attached to the ATM. During the ATM reconciliation process, operation device information is needed for each device and for application. The application specific device information is gathered by software extensions to the XFS components which operate the devices of the ATM.

### FIELD OF THE INVENTION

The present invention relates to maintaining device specific information for a self-service system.

### BACKGROUND

Self service terminals (SST) are public access devices that provide goods and services to customers typically in an unattended environment. One common type of SST is an automated teller machine (ATM). Originally, ATMs executed a single application that provided a set of features and functions to customers using the ATM. The features and functions included checking the balance of an account, receiving currency and making deposits. The application operated the devices connected to the ATM to perform the features and functions. Reconciling the ATM was relatively easy because the single application operated the devices of the ATM and any action performed by a device was at the request of the single application.

ATM's can now execute a number of different applications and each application can operate the devices connected to the ATM. Reconciling the ATM is more difficult because each action of each device has to be reconciled back to the application that requested the action. The reconciliation requires querying each application to determine what functions they executed and what device was involved. Since applications can be provided by different vendors with different interfaces, the reconciliation process can be time consuming and complicated.

### SUMMARY

Among its several aspects, the present invention seeks to overcome or ameliorate at least one of the disadvantages of the prior art, or to provide a useful alternative.

Therefore, among its several aspects, the present invention recognizes that a self service terminal such as an automated teller machine (ATM) includes a computer and devices that support the functions of the ATM, for example a cash or note dispenser; a check, note or check acceptor; and a card reader to name a few. Applications operate the devices by sending commands to software components known as eXtensions for Financial Services (XFS) software. The XFS software includes a manager and device specific service providers. A standard ATM application is executed that operates the devices of the ATM to generate the features and functions used by a user of the ATM.

The present invention further recognizes that a computer within the ATM executes the standard ATM application and one or more additional applications that also use the devices of the ATM. In some cases, one or more of the additional applications are from a third party vendor. An example of an additional application is an interactive teller application that operates the devices of the ATM. The applications that run on the ATM use the XFS service providers to operate devices on the ATM.

The present invention additionally recognizes that periodically the ATM runs a reconciliation function to account for the financial instruments used by the ATM. The reconciliation process must determine which applications dispensed or accepted financial instruments. The standard XFS service providers maintain device count information for each device connected to the ATM. However, the device count information maintained by the standard XFS service providers does not include information sufficient to determine which application performed each operation of each device.

In accordance with an embodiment of the present invention, extensions to the standard XFS service providers are provided that add additional information to the device count information to determine which application performed each operation of each device. The extensions allow an accurate reconciliation process to be performed without having to query the different applications for device information. In some embodiments, the third party providing an application is charged for being allowed to use the ATM and the charges are based on the resources utilized and the functions performed.

In accordance with an embodiment of the present invention, there is provided a method implemented by a computer in a self service terminal to determine application specific device operation counts. The method comprising the steps of: receiving from a first application a command to operate a first device connected to the self service terminal; storing first application device specific information for the first device after receiving the command from the first application; receiving from a second application a command to operate the first device; and storing second application device specific information for the first device after receiving the command from the second application.

In accordance with another embodiment of the present invention, there is provided a self service terminal. The self service terminal comprises: a device; a first and second application, each of the first and second applications being operable to control the device; a device manager in communication with the first and second applications and being operable to: receive from the first application a command relating to the device; store first application information, where the first application information is associated with operations performed by the device in response to commands from the first application; receive from a second application a command relating to the device; store second application information, where the second application information is associated with operations performed by the device in response to commands from the second application.

A more complete understanding of the present invention, as well as further features and advantages of the invention, will be apparent from the following Detailed Description and the accompanying Drawings.

### BRIEF DESCRIPTION OF THE DRAWINGS

The present invention may take form in various components and arrangements of components and in various methods. The drawings are only for purposes of illustrating example embodiments and alternatives and are not to be construed as limiting the invention. The drawings are not necessarily drawn to scale. Throughout the drawings, like element numbers are used to describe the same parts throughout the various drawings, figures and charts.

FIG. 1 is a high-level block diagram illustrating a self service terminal in accordance with an embodiment of the present invention.

FIG. 2 is a high-level block diagram illustrating selected components of a computer within the self service terminal of FIG. 1.

FIG. 3 is a high-level block diagram depicting the software architecture of the self service terminal of FIG. 1.

FIG. 4 is a high-level flow diagram illustrating a method of operating the self service terminal of FIG. 1.

### DETAILED DESCRIPTION

In the following description, numerous details are set forth to provide an understanding of the claimed invention. However, it will be understood by those skilled in the art that aspects of the claimed invention may be practiced without utilizing all of these details and that numerous variations or modifications from the described embodiments are possible and envisioned.

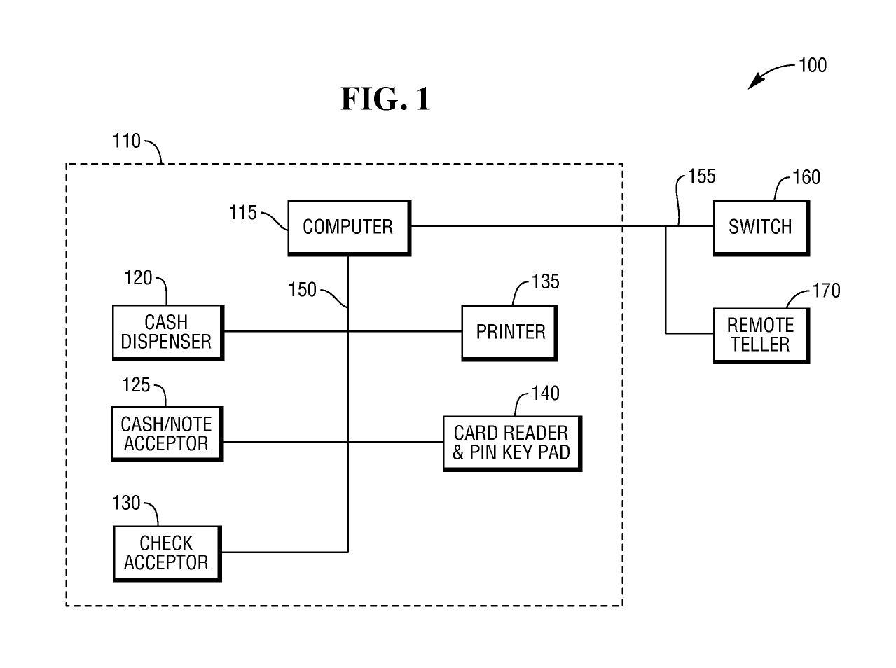

With reference to FIG. 1, there is provided a high-level block diagram illustrating a self service system 100. The self service system 100 of the present embodiment includes a self service terminal (SST) 110 in communication with a server computer 160 and a remote teller 170 using a network 155. The self service terminal 110 of this embodiment is an automated teller machine (ATM) and the server computer 160 is a switch that connects the ATM to a banking network. The ATM 110 performs functions for a user that include dispensing cash, accepting checks, cash and notes for deposit, checking account balances and other banking related functions.

The ATM 110 also communicates with a remote teller 170. The remote teller 170 is an application executing on a computer that allows a supervisor teller to communicate with a user of the ATM 110 over the network 155. The remote teller 170 can authorize the ATM 110 to perform certain functions. Although the switch 160 and the remote teller application 170 are shown in FIG. 1 as being coupled to the same network, in other embodiments they may be accessed by the ATM 110 via different networks.

Although only one ATM 110 is depicted, it should be appreciated that the self service system 100 supports multiple ATMs 110 that use the network 155 to communicate with the server computer 160.

The server computer 160 may communicate with the ATM 110 using a defined message protocol. The defined message protocol may be an industry-standard message interface, such as IFX (Interactive Financial eXchange), ISO 8583, or the like; or a proprietary message interface, such as the NCR Direct Connect (NDC) message interface (from NCR Corporation™), the 91x message interface provided by Diebold, Inc.™, or the like.

The network 155 may suitably include a network which uses a communications protocol based on transmission control protocol/internet protocol (TCP/IP). The network 155 may suitably include a combination of local area and wide area networks. The network 155 may further suitably include any combination of wireless and wired networks. The wireless networks include local area wireless computer networks and cellular based data networks.

The ATM 110 suitably includes a pc core (for simplicity referred to herein as a computer) 115 coupled to a plurality of devices, including: a cash dispenser 120, a cash/note acceptor device 125, a check acceptor 130, a printer device 135, a card reader and key pad 140 and a computer network 150. The computer network 150 may include more than one type of network, each of which is used to communicate with different devices. The computer 115 communicates with the devices over the computer network 150 which may suitably include an implementation of the industry standard Universal Serial Bus (USB). The computer network 150 may additionally include a second network designed to communicate with a display device such as the operator display 240. The operator display 240 is used by customers of the ATM 110. The ATM 110 may suitable include a second service display (not shown) used by service personnel to service the ATM 110.

The cash dispenser 120 is controlled by the computer 115. The computer 115 sends commands to the cash dispenser 120. The commands cause the cash dispenser 120 to deliver a specified number and denomination of cash or currency.

The cash/note acceptor 125 is a device that accepts and counts cash and/or notes provided by a user. The cash/note acceptor 125 determines the number and denomination of the cash and/or notes that are received. This information is communicated to the computer 115. In some embodiments, the cash and/or notes can be recycled or made available for dispensing.

The check acceptor 130 is a device that accepts checks provided by a user. The checks are received and stored. In some embodiments, the check is photographed and the image of the check is transmitted to the computer 115 for processing. In some embodiments, instead of a cash/note acceptor and check acceptor, a single device that receives cash and checks may be used.

The printer 135 is used to print receipts and other messages related to a transaction being performed by the self service terminal 110.

The card reader and key pad devices 140 provide a means to read a credit or debit type card and a key pad for entering a personal identification number (PIN). In this embodiment, the card reader is a magnetic stripe reader which reads information from a magnetic stripe on a card that is moved through the device. For example, the card reader reads the magnetic stripes found on the back of credit, debit and loyalty cards plus magnetic stripes found on the back of some driver's licenses. In some embodiments, the card reader also has the ability to communicate with a processor located inside the card to retrieve information. The key pad allows a customer or operator to enter a personal identification number (PIN) that may be associated with the card. This information is then securely transmitted to the computer 115 over the computer network 150.

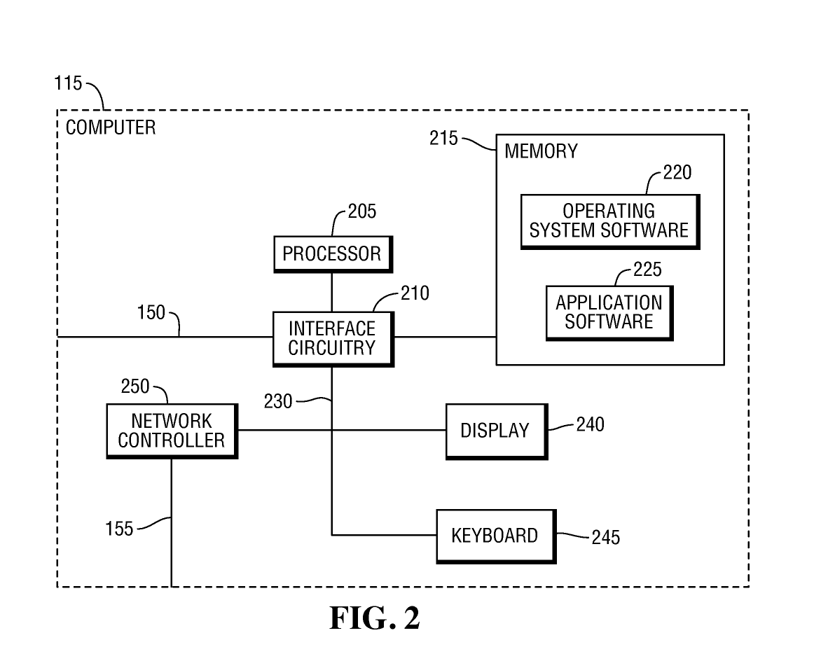

Turning now to FIG. 2, there is provided a high-level block diagram illustrating selected components of the computer 115. The computer 115 may suitably include a processor 205, interface circuitry 210, a memory 215, a display 240 and a keyboard 245. The interface circuitry 210 provides the electronics required for the processor 205 to communicate with the memory 215, the computer network 150 and the other devices and components of the computer 115 using a data network 230. The interface circuitry 210 generates the data network 230 that may suitably include electronics and software to generate an industry standard Universal Serial Bus (USB).

The memory 215 uses non-transitory storage devices that may suitably include both volatile and non-volatile memory. The non-volatile memory may include flash memory, other types of solid state electronic memory and rotating storage devices, such as disk drives or the like. Non-volatile memory retains stored information after power is removed from the memory and until power is restored.

Operating system software 220 and application software 225 are stored in the memory 215. The operating system software 220 and the application software 225 are comprised of computer instructions that are executed by the processor 205 and cause the processor 205 to perform the features and functions of the self service terminal 115. The computer instructions when executed by the processor 205 further cause the processor 205 to control the devices and components of the self service terminal 115.

In this embodiment, the operating system software 220 includes a Windows 7 (trademark) operating system, available from Microsoft Corporation (trademark). In other embodiments, the operating system software 220 includes other versions of Microsoft (trademark) operating systems or operating systems from different companies.

The display 240 is used to communicate with a user or operator. In some embodiments, the display 240 includes a touch screen device that detects touches by a user and communicates information about each touch to the processor 205. The keyboard may suitably include keys on either side of the display 240 and/or at other locations close to the display 240 and is used to receive information from a user.

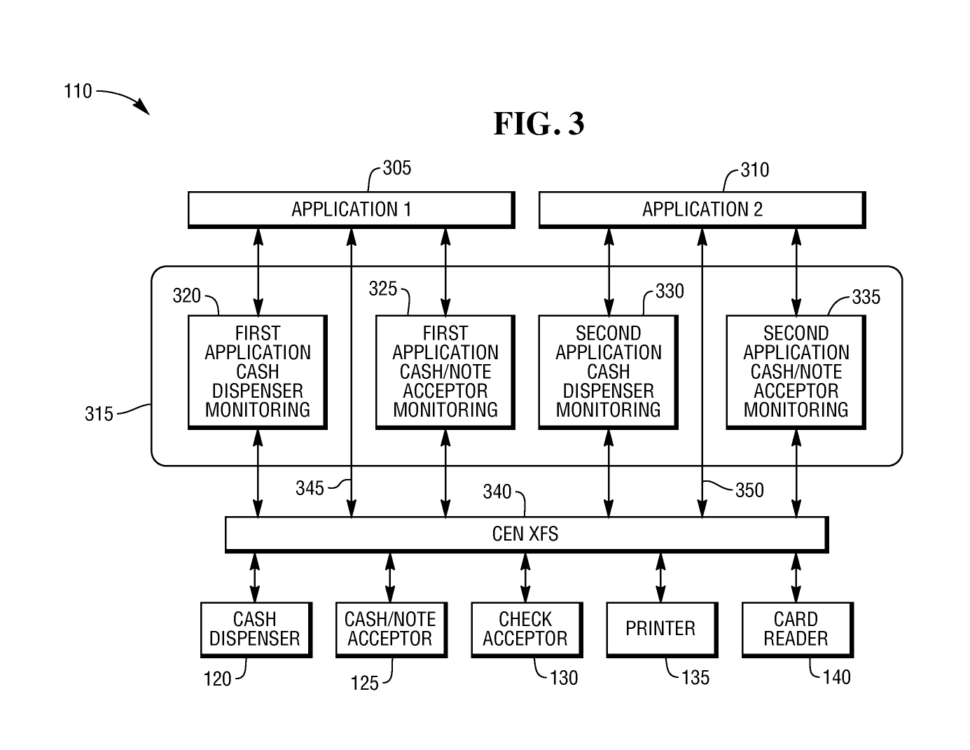

Reference is now made to FIG. 3, which is a high level block diagram depicting the architecture of the self service terminal 115. The diagram shows software and hardware components according to one embodiment of the present invention. The software components include the application software 225 having two parts: a first application 305 and a second application 310 that perform high level functions of the ATM 110. The applications 305, 310 present a sequence of screens on the display 240 to a customer at the ATM 110, collate information from the customer (for example, customer account information from a customer's ATM card, transaction requests, transaction amount, and the like), obtain authorization for a transaction request from a remote authorization host (not shown) through the switch 160, and communicate commands to other software components to operate devices 120, 125, 130, 135, 140 to perform authorized transactions.

In this embodiment, the first application 305 provides ATM functions and the second application 310 provides interactive teller functions. The first application 305 communicates through the computer server (switch) 160 to an application at a bank or other financial computer center to authorize certain operations such as cash dispense, balance enquiry, and the like. The second application 310 communicates with the remote teller application 170 where a supervisor teller can authorize certain operations. Other embodiments may suitably have more than two applications which perform different functions and communicate with different remote computers and applications. One or more of the applications executing on the ATM 110 may be from a third-party vendor that is, a vendor other than the vendor who supplied the ATM 110.

The European Committee for Standardization (CEN) provides a client-server architecture for financial applications on Microsoft Windows (trademark) platforms known as eXtensions for Financial Services (XFS). In this embodiment, the XFS software components 340 are included in an APTRA (trademark) software product, available from NCR Corporation, 3097 Satellite Blvd. Duluth, Ga. 30096, U.S.A. The XFS software components 340 are run-time extensions to the operating system and are included in the operating system software 220. The XFS software components 340 provides an XFS manager and service providers components that operate devices incorporated into the ATM 110. The components operate the cash dispenser 120, the cash/note acceptor 125, the check acceptor 130, the printer 135, and the card reader 140 as well as other devices not illustrated in the drawings.

The present embodiment includes middle layer software components 315 that include extensions to the standard XFS software components 340. FIG. 3 only depicts four components of the middle layer components 315. There are other components that monitor other devices incorporated into the ATM 110. The four components are a first application cash dispenser monitoring component 320, a first application cash/note acceptor monitoring component 325, a second application cash dispenser monitoring component 330 and a second application cash/note acceptor monitoring component 335. The middle layer components (software extensions) 315 communicate with the first and second applications 305, 310 and the standard XFS software components 340 and maintain application specific device information (such as counts) for each of the devices 120, 125, 130, 135, 140 incorporated into the ATM 110. Any commands issued by the applications 305,310 that are not related to one of the devices for which there is a monitoring component 320 to 335 are sent directly to the XFS software components 340. For example, in this embodiment, there is no monitoring component for the printer 135, so any printer commands issued by the first application 305 are sent directly to the printer 135. In such cases, the applications 305,310 bypass the middle layer components 315 and communicate directly with the XFS software components 340, as illustrated by arrows 345, 350 in FIG. 3. However, in other embodiments, all commands may be routed by the first and second applications 305,310 directly to the XFS software components 340 and the middle layer components 315 may monitor any commands relating to a device for which there is a monitoring component 320 to 335.

Standard XFS software does not provide a method to track device counts specific to each application running on the ATM 110. The standard XFS software components 340 only provide total device counts which are not broken down by application. Device counts include but are not limited to the number and type of operations a device performs at the request of an application. Count information includes for example the number and denomination of the cash or notes dispensed, the number and denomination of the cash, notes or checks accepted, the number of cards that were read and print operations.

Periodically, a supervisor function runs to reconcile the ATM 110 that is, to ascertain if the cash amount at the last reconciliation matches the cash dispensed and the cash remaining. The reconciliation function uses multiple device counts to reconcile the ATM 110. A settlement transaction uses the application specific device counts to perform a reconcile function for each application.

In some embodiments, the present invention is implemented as a software wrapper application that includes the middle layer components 315 and the XFS software components 340. The software wrapper exposes the XFS software components 340 interface in addition to the interface of the middle layer components 315. For commands that operate a device for which there is a middle layer component, the middle layer components 315 log each requested operation and then pass each command to the appropriate XFS software components 340 interface to perform the operation.

In still other embodiments, a device manager (not shown) provides the interface between applications and the middle layer components 315. In these embodiments, the first application 305 and the second application 310 send device commands to the device manager which then processes the commands and sends them to the appropriate XFS software components 340.

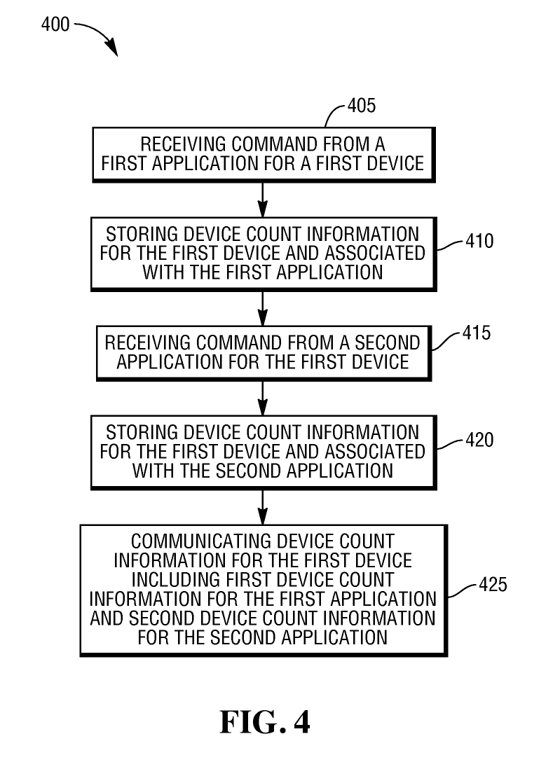

Turning now to FIG. 4, there is provided a high-level flow diagram illustrating a method 400 of operating the ATM 110 to execute applications 305, 310 which issue commands to operate devices 120, 125, 130, 135, 140 attached to the ATM 110. In the method 400, the first and second applications 305, 310 communicate through the software extensions 315 to the XFS software components 340 to send commands that operate the devices 120, 125, 130, 135, 140 connected to the ATM 110. The software extensions 315 maintain device count information for each device 120, 125, 130, 135, 140. The software extensions 315 further maintain information within the device count information that identifies which application 305, 310 requested a function that increased a device count. Thus, the device count information can be used to determine the number of operations issued by each application to each device 120, 125, 130, 135, 140.

In one possible example, application one 305 issues a command to the first application cash dispenser monitoring 320 component to dispense two twenty dollar bills from the cash dispenser 120. Once the two twenty dollar bills are dispensed without errors, the extended software 315 generates and stores device count information for the cash dispenser 120. The device count information includes: the time of the operation, the fact that two twenty dollar bills where dispense and that the operation was requested by application one 305. During the reconciliation process, the software extensions 315 will return aggregated device operating information by application and device or complete details on every operation. For example, the software extensions 315 may return information that application one 305 caused one hundred and twenty five (125) twenty dollar bills to be dispensed by the cash dispenser 120 and that application two 310 caused 412 twenty dollar bills to be dispensed by the cash dispenser 120. This information along with all the other device count information will allow the ATM 110 to be reconciled.

In step 405, the software extensions 315 receive a command from the first application 305 to perform an operation on a first device. The first device may suitably be any of the devices connected to the ATM 110. The operation may suitably be any function that can be performed by the device such as causing a cash dispenser to dispense one or more notes of a certain denomination or causing a printer to print a receipt.

In step 410, the software extensions 315 store device count information for the first device and associates the operation with the first application 305. In step 415, the software extensions 315 receive a command from the second application 310 to perform an operation on the first device. In step 420, the software extensions 315 store device count information for the first device and associate the operation with the second application 310.

In step 425, the software extensions 315 communicate device count information for the first device. The device count information includes details about operations performed by the first device at the request of the first application 305 and device information that includes details about the operations performed by the first device at the request of the second application 310. This information may suitably be used to reconcile the financial instruments of the ATM 110 that are used by the first application 305 and the second application 310.

Although the present invention has been described with particular reference to certain preferred embodiments thereof, variations and modifications of the present invention can be effected within the spirit and scope of the following claims.

What is claimed is:

1. A computer implemented method of providing application specific device information on a self service terminal in which multiple applications control the same device, the method comprising the steps of:
receiving from a first application a command to operate a first device connected to the self service terminal;
storing first application device specific information for the first device after receiving the command from the first application;
receiving from a second application a command to operate the first device; and
storing second application device specific information for the first device after receiving the command from the second application.

2. The method of claim 1, wherein storing first application device specific information for the first device comprises storing a count of the number of operations performed by the first device at the command of the first application and wherein storing second application device specific information for the first device comprises storing a count of the number of operations performed by the first device at the command of the second application.

3. The method of claim 1, further comprising communicating (i) the first application device specific information for the first device wherein the first application device specific information includes first information only for first device operations performed in response to commands from the first application and (ii) the second application device specific information wherein the second application device specific information includes first information only for first device operations performed in response to commands from the second application.

4. The method of claim 1, further comprising communicating the command from the first application to operate the first device to a software component to implement the command.

5. The method of claim 2, further comprising communicating the command from the second application to operate the first device to the software component to implement the command.

6. The method of claim 3, wherein the software component is an extension to an XFS component of the self service terminal.

7. The method of claim 1, wherein the self service terminal is an automatic teller machine.

8. The method of claim 1, further comprising reconciling the operations of the first and second application using device count information associated with the first application and the second application.

9. The method of claim 1, wherein the first device is a cash dispenser and the device specific information for the first device comprises a count of banknotes (number and value) dispensed by the first device.

10. The method of claim 1, wherein the first device is a cash or note acceptor and the device specific information for the first device comprises a count for each denomination of cash or notes accepted.

11. The method of claim 1, wherein the first device is a check acceptor.

12. The method of claim 1, wherein the first device is a card reader.

13. The method of claim 1, wherein the method is implemented with a software wrapper that includes XFS components and software that implements the steps of claim 1 and communicates with the XFS components and wherein the software wrapper exposes the software interface of the XFS components.

14. A self service terminal comprising:
a device;
a first and second application, each of the first and second applications being operable to control the device;
a device manager in communication with the first and second applications and being operable to:
receive from the first application a command relating to the device;
store first application information, where the first application information is associated with operations performed by the device in response to commands from the first application;
receive from a second application a command relating to the device;
store second application information, where the second application information is associated with operations performed by the device in response to commands from the second application.

15. The terminal of claim 14, further comprising communicating first and second application information to a third application, the third application being operable to perform a reconciliation function.

16. The terminal of claim 14, where the device is a cash dispenser.

17. The terminal of claim 14, where the device is a cash or note acceptor.

18. The terminal of claim 14, where the device is a check acceptor.

19. The terminal of claim 14, where the self service terminal is an automatic teller machine.

20. One or more non-transitory digital storage media storing data and instructions which, when the instructions are executed by one or more computing devices, cause performance of the method recited in claim 1.
